(19) United States
(12) Patent Application Publication
(10) Pub. No.: US 2022/0178125 A1
(43) Pub. Date: Jun. 9, 2022

(54) SEMI-AUTOMATIC TOILET BOWL SYSTEM

(71) Applicant: IZEN CO., LTD, Gimpo-si (KR)

(72) Inventor: Jung Han CHO, Seoul (KR)

(21) Appl. No.: 17/123,023

(22) Filed: Dec. 15, 2020

(30) Foreign Application Priority Data
Dec. 4, 2020 (KR) 10-2020-0168663

(51) Int. Cl. E03D 5/10

(52) U.S. Cl. CPC E03D 5/105

(57) ABSTRACT

The present disclosure relates to a semi-automatic toilet bowl system that automatically closes a toilet cover and performs flush by sensing that a user finishes relieving nature after manually opening the toilet cover to relieve nature. More particularly, the present disclosure relates to a semi-automatic toilet bowl system that can prevent excreta and toilet water from flying outside, can semi-automatically open a cover only when the toilet is used, and can prevent power consumption for opening the toilet by automatically rotating and closing the toilet cover and automatically performing flush when a user who feels nature's call manually open the toilet cover and then finishes relieving his/her nature.

### CROSS-REFERENCE TO RELATED APPLICATIONS

This application claims the benefit under 35 U.S.C. section 119, which claims foreign priority to Korean Patent Application No. KR10-2020-0168663, filed on Dec. 4, 2020, in the Korean Intellectual Property Office, the disclosure of which is hereby incorporated by reference in its entirety.

### BACKGROUND OF THE DISCLOSURE

### Field of the disclosure

The present disclosure relates to a semi-automatic toilet bowl system that automatically closes a toilet cover and performs flush by sensing that a user finishes relieving nature after manually opening the toilet cover to relieve nature. More particularly, the present disclosure relates to a semi-automatic toilet bowl system that can prevent excreta and toilet water from flying outside, can semi-automatically open a cover only when the toilet is used, and can prevent power consumption for opening the toilet by automatically rotating and closing the toilet cover and automatically performing flush when a user who feels nature's call manually open the toilet cover and then finishes relieving his/her nature.

### Related Art

A toilet that is used for people to relieve their natures is configured such that a user opens the cover of the toilet, relives his/her nature on the toilet, and then flushes the excreta down the toilet using a flushing device in the water tank.

Recently, in order to prevent a restroom from being not sanitarily managed due to users who forgets flushing with the development of sensors, an “Automatic water drain device of camber pot” (hereafter, referred to as a related art 1) has been disclosed in Korean Patent No. 10-1975273, issued on Apr. 29, 2019, which performs flush by automatically operating an operation lever when sensing that a user left through a sensor after the user finishes relieving his/her nature.

However, since flush is automatically performed even though there is a user in a stall with a toilet, the water in the toilet bowl flies including excreta, which sticks to the user or makes the user unpleasant. Further, since the water including excreta may scatter in the air, it is difficult to keep the toilet sanitary.

As a related art 2 for solving this problem, an “Automatic sanitary chamber system” (hereafter, referred to as a related document 2) has been disclosed in Korean Patent No. 10-1909714 issued on Oct. 12, 2018.

According to the related art 2, a cover is opened up when a sensing unit senses a user, and water is supplied to a main body and the cover is rotated by the pressure of the water to cover the top of the main body such that flush can be performed with the cover closed when the sensing unit senses that the user left.

However, according to the related art 2, since the cover covers the top of the main body by water pressure that changes simultaneously with flush, it is possible to prevent water from excessively flying. However, since flush is performed with the toilet partially open, it is difficult to completely solve the problem of scattering. Further, since the cover is automatically rotated and opened only when a user is completely sensed, the toilet cover may not be opened up even though a user enters a stall unless the user is quickly and accurately sensed.

Further, since power is consumed to rotate the cover, but most users manually opens the cover when they want to quickly use the toilet due to urgency, there is a problem that it is actually difficult to wait for opening of the cover and power is consumed.

### SUMMARY OF THE DISCLOSURE

In order to solve the problems described above, an objective of the present disclosure relates is to provide a semi-automatic toilet bowl system that can prevent excreta and toilet water from flying outside, can semi-automatically open a cover only when the toilet is used, and can prevent power consumption for opening the toilet by automatically rotating and closing the toilet cover and automatically performing flush when a user who feels nature's call manually open the toilet cover and then finishes relieving his/her nature.

Another objective of the present disclosure is to provide a semi-automatic toilet bowl system that can prevent a user from inhaling excreta and toilet water, which may scatter and fly outside, and can be sanitarily used by rotating and opening a cover after counting the time for which there is no user, counting the time for which the cover has been closed, and performing flush.

Another objective of the present disclosure is to provide a semi-automatic toilet bowl system that can be easily washed and can easily discharge urine by preventing a cover from automatically rotating or preventing automatic flush when rotating a seat cover for washing or discharging men's urine.

Another objective of the present disclosure is to provide a semi-automatic toilet bowl system that enables a user who has a dislike to use a toilet with the cover closed to easily use a toilet by informing the user of the available state and that can remove a stink remaining in the toilet bow due to long-period use so that a user can use the toilet in a pleasant environment.

The objects of the present disclosure are not limited to the objects described above and other objects will be clearly understood by those skilled in the art from the following description.

In order to solve the problems described above, a semi-automatic toilet bowl system according to the present disclosure includes: a toilet disposing of excreta of a user; a sensing unit sensing that a cover of the toilet is opened and the toilet is used; a counting unit counting a pre-input time when the sensing unit senses that a user uses the toilet; and a controller controls the cover of the toilet to close or the toilet to perform flush when the counting unit finishes counting the pre-input time, in which the counting unit is composed of: a primary counting module counting a pre-input time when the sensing senses that a user leaves the toilet; and a secondary counting module counting a pre-input time when the cover of the toilet is closed, and the controller rotates the cover of the toilet to close and drives the second counting module in response to a signal transmitted from the primary counting module that finishes counting, and controls the toilet to perform flush in response to a signal transmitted from the secondary counting module that finishes counting.

The sensing unit may include: a cover opening/closing sensing module sensing a closed or open state of the cover of the toilet; a use sensing module sensing whether a user uses and leaves the toilet; and a seat cover sensing module sensing whether a seat cover of the toilet is rotated, in which when the seat cover sensing module senses that the seat cover of the toilet is opened up, the use sensing module may be driven and senses the user.

When the seat cover sensing module senses that the seat cover is opened up, but the use sensing module senses that there is no user, the controller may control the seat cover to automatically rotate over a bowl of the toilet.

The controller may include: a toilet control module controlling operation of the toilet; a sensing unit control module receiving a signal from the sensing unit and controlling driving of the sensing unit; a counting unit control module receiving a signal from the counting unit and controlling driving of the counting unit; and a memory storing time input in advance in the counting unit.

The toilet may include a speaker outputting an information voice informing a user that the toilet is available, the sensing unit may include an entry sensing module sensing that a user enters a toilet stall equipped with the toilet, and when the entry sensing module senses that a user enters the toilet stall, the controller may output an information voice saying that the toile is available to the user by driving the speaker.

### BRIEF DESCRIPTION OF THE DRAWINGS

FIG. 1 schematically shows the configuration of a semi-automatic toilet bowl system according to the present disclosure.

FIG. 2 shows the configuration of the semi-automatic toilet bowl system according to the present disclosure.

FIG. 3 shows a state in which a cover according to the present disclosure is open.

FIG. 3A shows a state in which a cover according to the present disclosure is closed.

FIG. 3B shows a state in which a seat cover according to the present disclosure is open.

FIG. 4 shows a toilet control module according to the present disclosure.

FIG. 5 is a flowchart showing an embodiment of the semi-automatic toilet bowl system according to the present disclosure.

FIG. 6A and FIG. 6B are a flowchart showing other embodiments of the semi-automatic toilet bowl system according to the present disclosure.

FIGS. 7 and 8 schematically show other embodiments of the semi-automatic toilet bowl system according to the present disclosure.

### DESCRIPTION OF EXEMPLARY EMBODIMENTS

The present disclosure may be modified in various ways and implemented by various exemplary embodiments, so that specific exemplary embodiments are shown in the drawings and will be described in detail.

However, it is to be understood that the present disclosure is not limited to the specific exemplary embodiments, but includes all modifications, equivalents, and substitutions included in the spirit and the scope of the present disclosure. Similar reference numerals are assigned to similar components in the following description of drawings.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only to describe specific exemplary embodiments rather than limiting the present disclosure. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Hereinafter, embodiments of the present disclosure are described with reference to the accompanying drawings. Like reference numerals given in the drawings indicate like components. In the description of the present disclosure, detailed description of well-known relevant functions or configurations is omitted not to make the spirit of the present disclosure unclear.

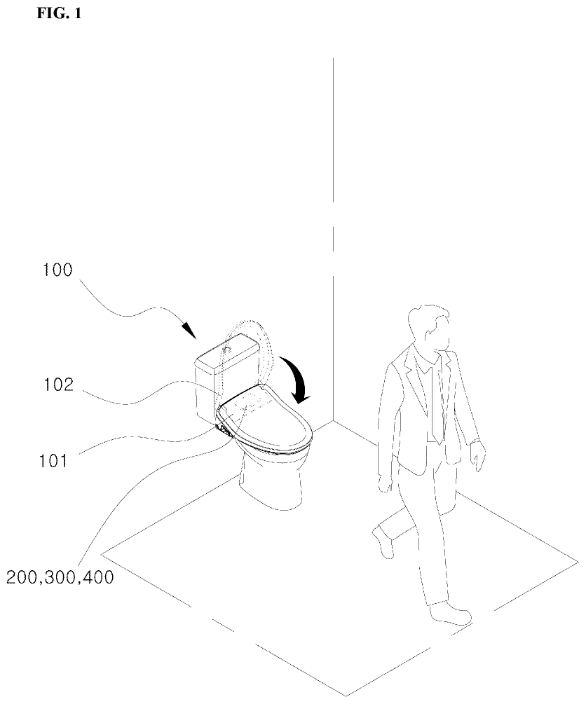

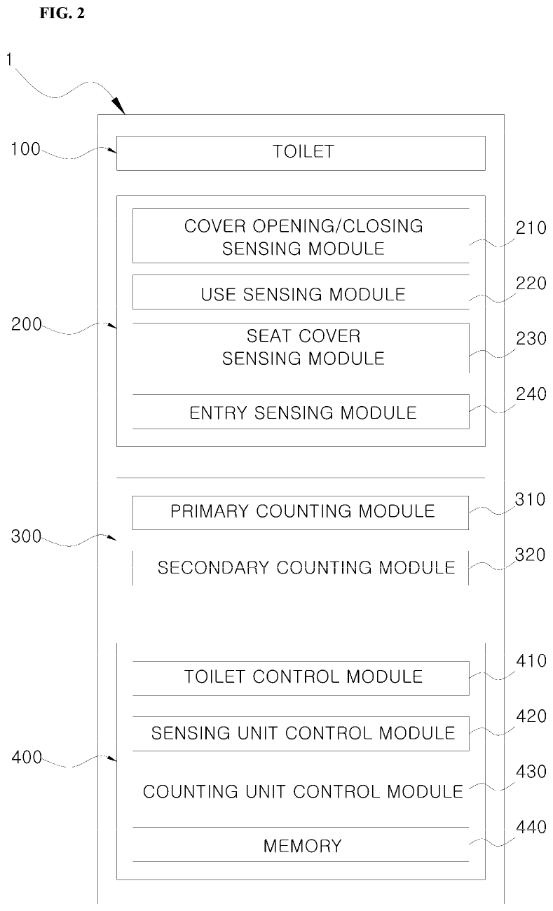

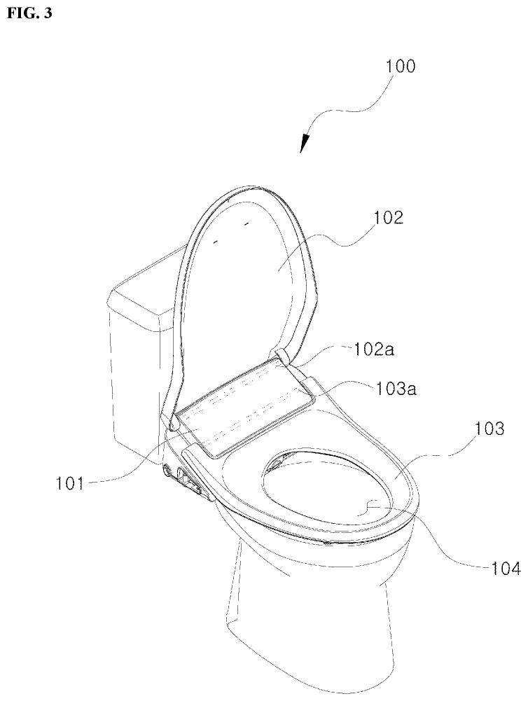

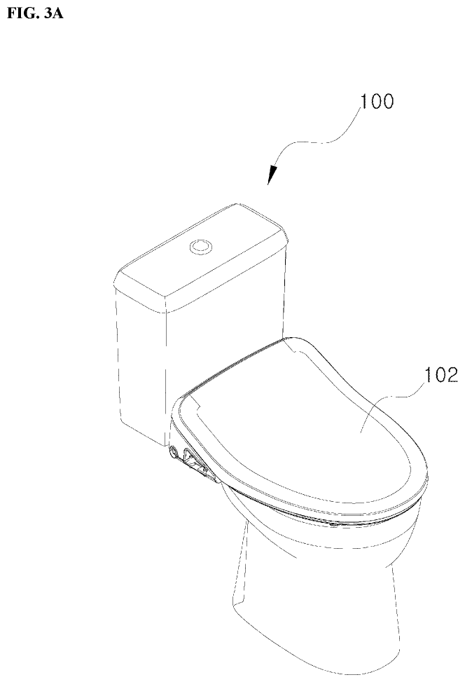

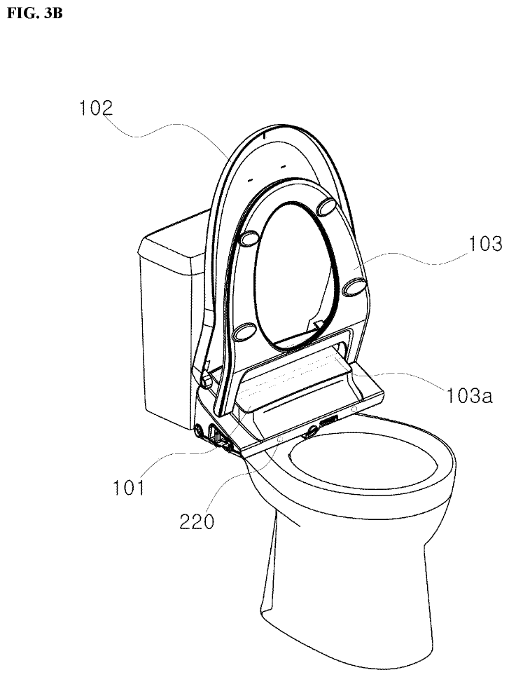

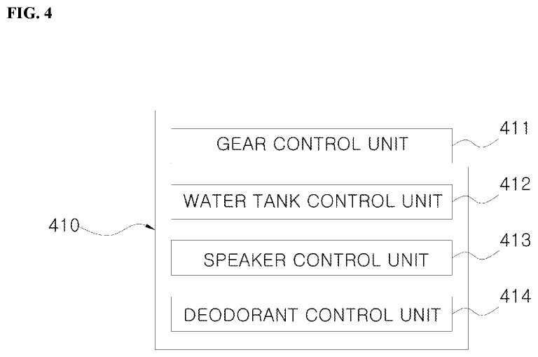

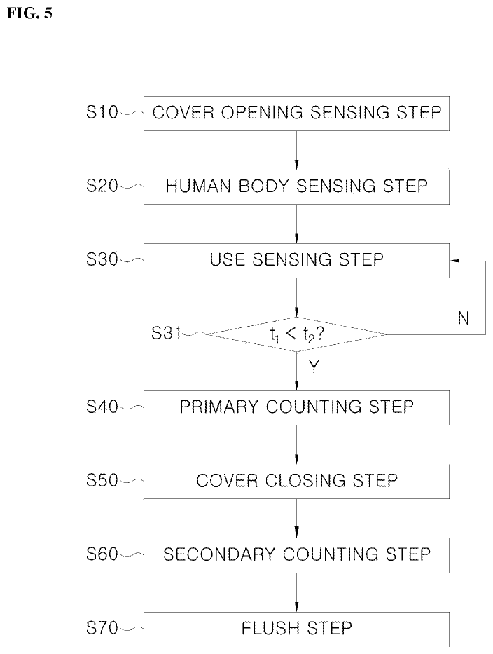

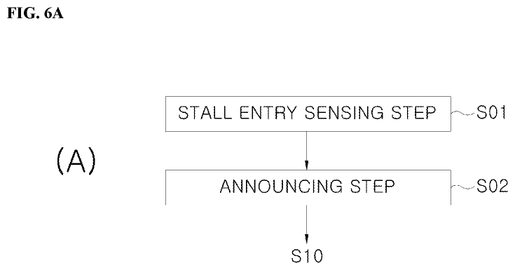

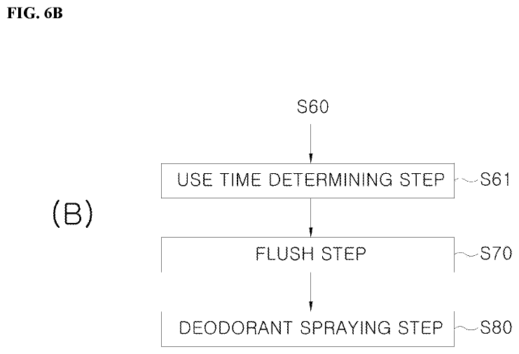

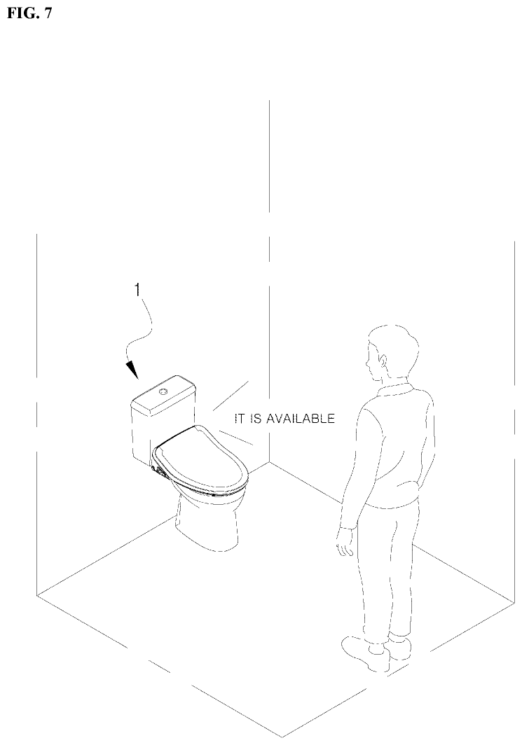

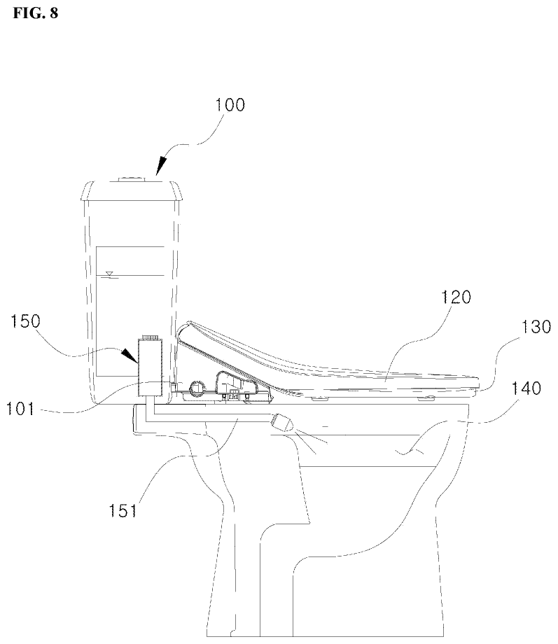

FIG. 1 schematically shows the configuration of a semi-automatic toilet bowl system according to the present disclosure, FIG. 2 shows the configuration of the semi-automatic toilet bowl system according to the present disclosure, FIG. 3 shows a state in which a cover according to the present disclosure is open, FIG. 4 shows a state in which a cover according to the present disclosure is closed, FIG. 3B shows a state in which a seat cover according to the present disclosure is open, FIG. 4 shows a toilet control module according to the present disclosure, FIG. 5 is a flowchart showing an embodiment of the semi-automatic toilet bowl system according to the present disclosure, FIG. 6A and FIG. 6B are a flowchart showing other embodiments of the semi-automatic toilet bowl system according to the present disclosure, and FIGS. 7 and 8 schematically show other embodiments of the semi-automatic toilet bowl system according to the present disclosure.

The present disclosure relates to a semi-automatic toilet bowl system 1 that automatically closes a cover of a toilet 100 and performs flush by sensing that a user finishes relieving nature after manually opening the cover 102 of the toilet 100 to relieve nature. The semi-automatic toilet bowl system 1 includes a toilet 100, a sensing unit 200, a counting unit 300, and a controller 400.

The toilet 100, which enables a user to relieve his/her nature, is composed of a main frame 101 including the sensing unit 200, the counting unit 300, and the controller 400 therein and disposed on the front of the toilet 100, and a toilet bow 104 having a cover 102 and a seat cover 103, which are connected with the main frame 101 to rotate, and receiving and discharging excreta of a user to sewerage.

The main frame 101 has both side ends coupled to the end of a side of each of the cover 102 and the seat cover 103, so the cover 102 and the seat cover 130 can rotate about the main frame 101.

Cover gears 102a respectively coupled through both sides of an end of the cover 102 and seat cover gears 103a coupled through both sides of an end of the seat cover 103 through the main frame 101 are disposed inside the main frame 101.

The cover gears 102a and the seat cover gears 103a are formed in bar shape, have several teeth around the outer surface, and can be fitted in coupling grooves (not shown in the figures) formed in shapes, which correspond to the cross-sections of the ends of both sides of the cover gear 102a and the seat cover gears 103a, at both sides of an end of the cover 102 and the seat cover 103. The cover gears 102a and the seat cover gears 103a are connected to motors (not shown in the figures) disposed in the main frame 101, so the motors (not shown in the figures) respectively rotate the cover gears 102a and the seat covers 103a connected thereto through the controller 400 so that the cover 102 and the seat cover 103 can rotate.

The cove gears 102a and the seat cover gears 103a are operated not to quickly rotate and close, but to slowly rotate, thereby being able to prevent a collision between the seat cover 103 and the bottom of the cover 102 and between the toilet 100 and the bottom of the seat cover 103. Further, since noise is not generated, it is possible to prevent a problem that a user may be surprised due to sudden closing of the cover 102 and the seat cover 103 even if the user is in the stall of the toilet 100.

The cover 102 is disposed over the seat cover 103 disposed on the top of the toilet bowl 104 to keep the toilet or a user opens the toilet bowl 104 by manually rotate the cover 102 rearward. When a user finishes his/her nature on the seat cover 103 and flush is automatically performed by the controller 300, the cover 102 is rotated and closed to be able to prevent toilet water including excreta from flying outside and prevent excreta and toilet water from scattering outside while the excreta is discharged.

The cover 102, as described above, has both side ends coupled to both side ends of the main frame 101, so the cover 102 can be opened or closed with rotation of the cover gears 102a.

According to the present disclosure, a user opens the toilet bowl 104 (see the state in FIG. 3) to relieve his/her nature by manually opening up the cover 102 which has been closed, and then relieves his/her nature. Further, the cover gears 102a are rotated to close the cover 102 through the sensing unit 200 sensing that a user finishes relieving his/her nature, etc., whereby the cover 102 is closed (see FIG. 3A).

Since the seat cover 103 is a common toilet seat, it is the seat of a toilet, so a user can relieve his/her nature, sitting on the seat cover 103.

Meanwhile, the seat cover 103 may be rotated rearward when a man relieves his nature or may be opened up for washing, etc.

However, the distance between the user and the toilet 100 is slight large, so there is a possibility that flush may be automatically performed while washing or urinating.

Accordingly, as shown in FIG. 3B, a user sensing module 220 that can sense the front surface of the main frame 101, that is, a user (a manager who performs washing, a men who urinates, etc.) when the seat cover 103 is opened up, so the controller 400 can control the toilet bowl system not to automatically rotate the cover 102 and perform flush.

Further, a switch (not shown in the figures) connected with a water tank filled with flush water in the toilet 100 to be able to perform flush may be provided.

The sensing unit 200, which can sense the toilet 100 and a user who uses the toilet 100, may include a cover opening/closing sensing module 210, a use sensing module 220, and seat cover sensing module 230.

The cover opening/closing sensing module 210, which senses the cover 102 opened by a user to use the toilet or the cover 102 currently closed, is disposed in the main frame 101 and can determine that the cover 102 is current open or closed by checking rotation and the degree of rotation of the cover gears 102a.

When a user manually opens up the cover 102 to use the toilet 100, the cover opening/closing sensing module 210 senses and transmits it to a toile control module 410 of the controller 400, and accordingly, the toilet control module 410 recognizing that the user is using the toilet 100 can drive the use sensing module 220.

The cover opening/closing sensing module 210 may be composed of a hydraulic sensor and a contact switch, a weight sensor, a pressure sensor, etc. that can check the degree of rotation of the cover gears 102a.

In the prior art related to an automatic toilet system in the related art, since it is required to continuously drive a human body sensor to sense a human body, there may be a problem of power consumption by the sensor and reduction of the lifetime due to long-period use. However, in the present disclosure, since the cover 102 is manually opened, it is possible to minimize power consumption and the number of times of using the use sensing module 220 by driving the use sensing module 220 that senses a user simultaneously with opening the cover 102.

The use sensing module 220, which senses a user who uses the toilet 100 after opening the cover 102, is disposed in the main frame 101 and is connected with the seat cover gears 103a. Accordingly, when the seat cover gears 103a are pressed by the body of a user, the fine downward movement of the seat cover 103 is sensed through the seat cover gears 103a, so it is possible to sense that the user is using the toilet 100.

Not in the type in which it is additionally disposed on the front of the main frame 101 and presses the seat cover 103, as described above, it is possible to sense a user positioned on the front of the toilet 100 when opening up the seat cover 103 and relieving his/her natural or performing washing.

The use sensing module 220 may be composed of a weight sensor, a motion sensor, a pressure sensor, etc. that are disposed in the main frame 101 and can sense the weight or the motion of the seat cover gears 103a to be able to pressure on the seat cover 103, and when the use sensing module 220 is disposed on the front of the main frame 101, the use sensing module 220 may be composed of a far infrared sensor that can sense the body of a user, etc., but the present disclosure is not limited thereto.

Accordingly, the user sensing module 220 can determine whether a user has left the seat cover 103 on the basis of the degree of a sensor value, can determine that a user is relieving his/her natural when the sensor value sensed by the use sensing module 220 is a set value set in advance in the use sensing module 220 or more, and can determine that a user has left the seat cover 103 when the sensor value is less than the set value.

The seat cover sensing module 230 senses the state of the seat cover 103, that is, whether the seat cover 103 is on the top of the toilet bowl 104, as shown in FIG. 3A, or whether the seat cover 103 has been opened up by a user. When a user opens up the seat cover 103 and leaves a stall without closing the seat cover 103 after relieving his/her natural, the use sensing module 220 senses that there is no user and then the seat cover 103 is rotated and positioned on the top of the toilet bowl 104.

The seat cover sensing module 230, similar to the cover opening/closing sensing module 210, can sense the state of the seat cover 103 by sensing rotation and the degree of rotation of the seat cover gears 103a. When sensing that the seat cover 103 has been opened up, the seat cover sensing module 230 transmits a signal to the toilet control module 410 such that the toilet control module 410 operates the use sensing module 220 to be able to the body of a user.

The seat cover sensing module 230 may be composed of a contact switch, a hydraulic sensor, a pressure sensor, a weight sensor, etc. to be able to check rotation of the seat cover gears 103a.

Accordingly, through the seat cover sensing module 230, when a user urinates standing up or a manager who washes the toilet bowl 104 after opening up the seat cover 103 is in a stall, the seat cover 103 and the cover 102 are prevented from automatically rotating and closing and automatic flush is also prevented. Accordingly, it is possible to prevent interference with washing or prevent urine and toilet water from flying out of the toilet 100 due to flush during relieving.

An entry sensing module 240, which senses a user entering a stall in which the toilet 100 is installed, may be composed of an ultrasonic sensor, a voice sensing module that can sense the sound of opening/closing of the door or a stall, a temperature sensor, etc.

When a user enters a stall, the entry sensing module 240, as described below, can prevent the user from hesitating to use the toilet 100 due to the closed cover 101 and output a sound to inform the user that the toilet is available.

Meanwhile, according to the prior art of the related art, flush is automatically performed when it is sensed that there is no user, but when a user is a little far from the toilet, particularly, even if a user stands up for a short time when a pressing sensor is in the seat cover 103, it is determined that there is no user, and flush is quickly performed.

In this case, as described above, there is a problem that toilet water including excreta in the toilet bowl 104 may fly outside or scatter, and particularly, may stick to the body of a user, which is not sanitary.

Accordingly, the present disclosure includes a counting unit 300 that counts a predetermined time so that the cover 102 is automatically closed after a user sufficiently relieves his/her natural, without simply closing the cover 102 and performing flush immediately after it is sensed that there is no user, and so that flush can be performed after a user leaves a stall with the toilet 100.

The counting unit 300 is composed of: a primary counting module 310 that counts a predetermined time and then rotates the cover 102 through the controller 400 to close the cover 102 when it is sensed that there is no user through the use sensing module 220; and a secondary counting module 320 that counts a predetermined time and then performs flush through the controller 400 when the cover opening/closing sensing module 210 senses that the toilet bowl 104 has been closed with the cover 102 closed.

The primary counting module 310 has a possibility that when a user stands up for a short time while relieving his/her nature or when the cover 102 is immediately rotated while a user cleans up, the cover 102 hits against the body of a user such as a hip, and if sever, excreta not removed yet by the user sticks to the front of the cover 102. Further, a user may feel inconvenient or unpleasant due to the cover 102 and the body of a user hitting against each other.

Accordingly, when the use sensing module senses that there is no user, the primary counting module 310 counts a predetermined time such that a user can clean up and then sufficiently move away from the toilet 100, and then transmits a signal to the toile control module 410 of the controller 400 so that the toilet control module 410 rotates the cover gears 102a such that the cover 102 closes the toilet bowl 104.

That is, when the seat cover gears 103a senses a user leaving the seat of the toilet or a use sensor (including an ultra-infrared sensor) that may be additionally disposed in the seat cover 103 senses a user leaving the seat cover 103, the use sensing module 220 determines that the user finishes relieving hit/her natural and enables the primary counting module 301 to perform counting.

The time that is counted by the primary counting module 310 may be freely set by the manufacturer and may be usually set as 3 seconds (time for which a user stands up or leaves the seat cover 103 for a short time) to 5 seconds (time for cleaning up with tissues and throwing the tissues into the toilet or a wastebasket), but the present disclosure is not limited thereto.

Further, when a user sits back on the seat cover 103, that is, on the seat of the toilet while the primary counting module 310 counts, the primary counting module 310 stops counting and has to start again counting after sensing that the user has left the seat of the toilet.

When the cover 102 is closed by the toile control module 420 after the primary counting module 310 counts a predetermined time, the secondary counting module 320 makes sure that the cover 102 has been closed through the cover opening/closing sensing module 210, counts a predetermined time, and then transmits a signal to the toilet control module 410 so that flush can be performed.

The secondary counting module 320, which counts the time for which a user who finishes cleaning up dresses and leave the stall while the first counting module 310 counts, usually counts around 5 seconds from 2 seconds after the cover 102 is closed. Accordingly, when a user leave a toilet stall, flush is performed, thereby preventing the influence on the user by excreta and toile water that may scatter outside even though the cover 102 is closed.

It is sensed that there is no user, and closing of the cover 102 and flush are prevented through the counting unit 300 described above, whereby it is possible to prevent a user from feeling unpleasant or induce a user not to be influenced by scattering excreta and toile water.

Meanwhile, the primary counting module 310 and the secondary counting module 320 outputs an information message using a sound or volumes up a signal sound or decreases the output interval of a signal sound as the counting time is reached, thereby being able to inform a user that the cover 102 is closed or flush is automatically performed after a pre-input time.

The controller 400 may include the toilet control module 410 that controls the components included in the toilet 100, a sensing unit control module 420 that determines a sensor value received from the sensing unit 200 and can control driving of the sensing unit 200, a counting unit control module 430 that controls driving of the counting unit 300, and a memory 440.

The toilet control module 410, as shown in FIG. 4, includes: a gear control unit 411 that can rotate the cover gears 102a and the seat cover gears 103 a; a water tank control unit 412 that controls the water tank in the toilet 100 so that flush can be performed; a speaker control unit 413 that can control a speaker (not shown in the figures) disposed in the frame 101 to be able to output an information message to a user as a sound; and a deodorant control unit 414 that controls a deodorant storage tank 140 and a deodorant spray nozzle 151 to be described below.

The gear control unit 411 performs a control operation that automatically rotates the cover gears 102a such that flush can be automatically performed in a closed state, and automatically rotates the seat cover gears 103a such that the seat cover 103 can be positioned on the top of the toilet bowl 104 before the cover 102 is closed.

When closing of the cover 102 is sensed by the cover opening/closing sensing module 210 and the secondary counting module 320 counts a predetermined time and then transmits a signal to the water tank control unit 412, the water tank control unit 412 receiving the signal operates the water tank filled with flush water to automatically perform flush. The water tank control unit 412 is connected with a switch for driving the water tank so that the toilet 100 can automatically perform flush without a user operating a specific flush lever. Accordingly, it is possible to automatically perform flush even if a user left without flushing and a user does not need to touch a flush lever that many unspecified people touch, so there is an advantage that the toilet 100 can be sanitarily used.

The speaker control unit 413 controls a speaker that outputs a counting sound of the counting unit 300 or a sound that can inform a user that the toilet 100 is available when the user entering a toilet stall is sensed through the entry sensing module 240.

The deodorant control unit 414 controls the deodorant storage tank 150 and the deodorant spray nozzle 151 to be described below such that a deodorant is sprayed into the toilet bowl 104 with the cover 102 closed, thereby being able to prevent a stink from remaining in the toilet bowl 104 and enable a user to use the toilet 100 in a pleasant environment.

The sensing unit control module 420 receives a signal from the sensing unit 200 and determines it, and accordingly, controls the operation of the components in the toilet 100 through the toilet control module 410.

That is, when the cover opening/closing sensing module 210 senses that the cover 102 is closed, it transmits a relevant signal to the sensing unit control module 420, and the sensing unit control module 420 receiving the signal can control the primary counting module 310 to count a pre-input time through the counting unit control module 430.

The counting unit control module 430 controls the signal receiving from the sensing unit control module 420 to perform the operations (counting a pre-input time) of the primary and secondary counting modules 310 and 320.

The memory 440 is a place in which the counting time of the counting unit 300, an expected use time (t₂) to be described below, etc. are stored, and the controller 400 can control the toilet 400 and the counting unit 300 in accordance with a pre-input time stored in the memory 400.

A method of automatically closing the cover and performing flush through the semi-automatic toilet bowl system 1 including the configuration described above is described together with FIG. 5.

First, the method perform a cover opening sensing step (S10) that senses opening of the cover 102 through the cover opening/closing sensing module 210 when a user enters a toilet stall equipped with the toilet 100 and opens the cover 102 to relieve his/her natural. Thereafter, the method performs a human body sensing step (S20) in which the seat cover sensing module 230 senses there is a user from a motion of sitting on the seat cover 103 or opening up the cover 102 and the seat cover 103, and then performs a use sensing step (S30) that senses use of the toilet 100 through the use sensing module 220 when the user relieves his/her natural.

The method performs a step (S31) that compares an expected use time (t₂) input in advance in the memory 440 with an actual use time (t₁) for which the user actually uses the toilet 100 through the use sensing module 220 to keep sensing use of the toilet 100 by the user when the actual use time (t₁) is longer than the pre-input expected use time (t₂); and performs a primary counting step (S40) in which the primary counting module 310 counts a pre-input time by determining that the user finishes relieving his/her natural when it is determined that the actual use time (t₁) is shorter than the expected use time (t₂).

When finishing the primary counting step (S40), the method perform a cover closing step (S50) in which the cover 102 is automatically rotated and closed; performs a secondary counting step (S60) in which the secondary counting module 320 counts a pre-input time before flush is started before performing a flush step (S70); and then performs the flush step (S70) that automatically performs flush.

By performing flush with the cover 102 closed through the steps (operations), there is an effect that it is possible to water from flying or scattering due to the flush and the next user can use the toilet 100 in a sanitary state.

Further, since flush can be automatically performed even without touching a lever that many unspecified people touch for flush, it is possible to provide a sanitary environment to users.

Meanwhile, since the present disclosure performs the flush step (S70) with the cover 102 automatically closed after a user finish relieving his/her natural, the cover 102 keeps close the toilet bowl 104 after that.

Thereafter, a user opens the toilet 100 by manually opening up the cover 102 and then relieves his/her natural. A user who uses the semi-automatic toilet bowl system 1 according to the present disclosure for the first time may have a dislike to use the toilet 100 by imaging a problem, for example, that there are excreta remaining in the toilet 100 or the toilet 100 has been clogged because the cover 102 is closed.

Accordingly, in order for a user to open the cover 102 and use the toilet 100 at ease, it is required to inform the user that the toilet 100 is available through the main frame 101 mounted on the toilet 100.

In order to solve this problem, as shown in FIG. 6A, the method may further include:

a stall entry sensing step (S01) that can sense a user entering a stall; and an announcing step (S02) that can inform the user entering the stall that the toilet 100 is available, before the cover opening sensing step (S10).

The stall entry sensing step (S01), which is a step of sensing that a user enters a partitioned toilet stall, can sense and check that a user enters a stall equipped with the toilet 100 by additionally including the entry sensing module 240 in the sensing unit 200.

The entry sensing module 240 may include a specific infrared sensor on the top of the main frame to directly sense going in and out, a motion, etc. of a user or a sound sensing sensor to sense and check going in and out of a user by sensing the sound of the door of the stall that is opened by the user.

The announcing step (S02) informs a user entering a toilet stall that the toilet 100 is available, as shown in FIG. 7, through the speaker control unit 413 in the toilet control module 410 using a speaker (not shown in the figures) that can output a sound message to the toilet 100, whereby the user can open up the cover 102 and use the toilet at ease.

Meanwhile, since after a user finishes relieving his/her natural, the cover 102 is automatically closed and the flush step (S70) is performed, the next user may have a smell of a stink and may feel unpleasant when the next user opens the cover 102 with the stink, etc. remaining in the toilet bowl 104.

In particular, when a user uses the toilet for a long time, the excreta exists for a long time in the toilet bowl 104, so the stink gets severe. Accordingly, the next user may have a smell of the stink when opening the cover 102.

Accordingly, in the present disclosure, the toilet 104 is equipped with both of the deodorant storage tank 150 and the deodorant spray nozzle 151. Further, as shown in FIG. 6B, the present disclosure performs the secondary counting step (S60) after the cover 102 is closed, and then may additionally perform: a user time determining step (S61) that determines whether the actual use time (t₁) of the toilet 100 by a user obtained in the use sensing step (S30) is longer than the pre-input expected use time (t₂); and a deodorant spraying step (S80) that drives the deodorant spray nozzle 151 so that the deodorant stored in the deodorant storage tank 150 can be sprayed into the toilet bowl 104 after the flush step (S70).

The use time determining step (S61) determines the difference between the actual use time and the expected use time (t₂) by comparing the actual use time (t₁) by a user obtained by the sensing unit 200 in the use sensing step (S30) with the expected use time (t₂) by the user input in advance in the controller 400, and enables the toilet control module 410 of the controller 400 to control driving of the deodorant storage tank 150 and the deodorant spray nozzle 151.

Since the larger the difference between the actual use time (t₁) and the expected use time (t₂), the larger the possibility that contamination by a stink remaining in the toilet bowl 104 gets severe, the toilet control module 410 determines a deodorant spray amount or the number of time of spraying the deodorant at a predetermined ratio in accordance with the difference between the actual use time (t₁) and the expected use time (t₂) and drives the deodorant storage tank 150 and the deodorant spray nozzle 151.

For example, when the difference between the actual use time (t₁) and the expected use time (t₂) is small and large, a difference is generated between the deodorant spray amount or the number of time of spraying the deodorant. Further, the deodorant is sprayed much more than the deodorant spray amount or the number of time of spraying the deodorant when the difference between the actual use time (t₁) and the expected use time (t₂) is large. Accordingly, there is an effect that it is possible to remarkably reduce the stink remaining in the toilet bowl 104 even though the cover 102 is closed.

Further, the deodorant may be replaced with an aromatic.

Further, when a user uses the toilet 100 over a predetermined time, there is a large amount of excreta or excreta remain the toilet 100 for a long time and accordingly the excreta may stick to the inner side of the toilet bowl 104. Accordingly, other than the deodorant spray step (S80), the intensity or the time of flush may be set higher than the existing intensity or time, whereby when a user uses the toilet 100 longer than a predetermined use time, it is possible to prevent excreta from remaining or sticking to the inside of the toilet bowl 104 by increasing the intensity and time of flush while spraying the deodorant.

Meanwhile, the toilet 100 according to an embodiment of the present disclosure may include a processor. The processor may include one or more core (not shown) and a connection channel (e.g., a bus) for transmitting/receiving a signal to/from a graphic processor (not shown) and/or another component.

The processor according to an embodiment can implement various embodiments of the present disclosure by executing one or more instructions stored in the memory 440.

Meanwhile, the processor may further include a Random Access Memory (RAM) (not shown) and a Read-Only Memory (ROM) (not shown) that temporarily or permanently store signals (or data). Further, the processor may be implemented in a System-on-Chip (SoC) type including at least one of a graphic processor, a RAM, and a ROM.

Programs (one or more instructions) for processing and controlling of the processor may be stored in the memory 440. The programs stored in the memory 440 may be separated into a plurality of modules in accordance with the functions of the stored programs.

As an embodiment, the memory 440 can store the primary counting module 310, the secondary counting module 320, the toilet control module 410, the sensing unit control module 420, and the counting unit control module 430, and the processor can implement various embodiments of the present disclosure by performing functions corresponding to the various modules stored in the memory 440.

The steps of the method or algorithm described in relation to embodiments of the present disclosure may be directly implemented by hardware, may be implemented by a software module that is executed by hardware, or may be implemented by a combination thereof. As software module may be permanently stationed on a RAM (Random Access Memory), a ROM (Read Only Memory), an EPROM (Erasable Programmable ROM), an EEPROM (Electrically Erasable Programmable ROM), a flash memory, a hard disk, a detachable disk, a CD-ROM, or a certain type of computer-readable recording medium well known in the art.

The components of the present disclosure may be implemented as programs (or applications) and stored in a medium to be connected with a computer, which is hardware, and executed. The components of the present disclosure may be executed by software programming or software elements. Similarly, embodiments may include various algorithms implemented by a data architecture, processes, routines, or a combination of other programming configurations, and may be implemented in a programming or scripting language such as C, C++, Java, and assembler. Functional terms may be implemented in an algorithm that is executed in one or more processors.

Optimal embodiments were disclosed in the drawings and the specification. Although specific terms were used, there are used only to describe the present disclosure, not to limit meanings or the scope of the present disclosure described in claims. Accordingly, those skilled in the art would understand that various and equivalent modifications can be achieved from the embodiments. Therefore, the technical protective region of the present disclosure should be determined by the scope described in claims.

As described above, according to the present disclosure, there is an effect that it is possible to prevent excreta and toilet water from flying outside, semi-automatically open a cover only when the toilet is used, and prevent power consumption for opening the toilet by automatically rotating and closing the toilet cover and automatically performing flush when a user who feels nature's call manually open the toilet cover and then finishes relieving his/her nature.

Further, there is an effect that it is possible to prevent a user from inhaling excreta and toilet water, which may scatter and fly outside, and sanitarily use a toilet by rotating and opening a cover after counting the time for which there is no user, counting the time for which the cover has been closed, and performing flush.

Further, there is an effect that a toilet can be easily washed and can easily discharge urine by preventing a cover from automatically rotating or preventing automatic flush when rotating a seat cover for washing or discharging men's urine.

Further, there is an effect that it is possible to enable a user who has a dislike to use a toilet with the cover closed to easily use a toilet by informing the user of the available state and to remove a stink remaining in the toilet bow due to long-period use so that a user can use the toilet in a pleasant environment.

The effects of the present disclosure are not limited to those described above and other effects may be made apparent to those skilled in the art from claims.

1. A semi-automatic toilet bowl system comprising:
a toilet disposing of excreta of a user;
a sensing unit sensing that a cover of the toilet is opened and the toilet is used;
a counting unit counting a pre-input time when the sensing unit senses that a user uses the toilet; and
a controller controls the cover of the toilet to close or the toilet to perform flush when the counting unit finishes counting the pre-input time,
wherein the counting unit is composed of:
a primary counting module counting a pre-input time when the sensing senses that a user leaves the toilet; and
a secondary counting module counting a pre-input time when the cover of the toilet is closed, and
the controller rotates the cover of the toilet to close and drives the second counting module in response to a signal transmitted from the primary counting module that finishes counting, and controls the toilet to perform flush in response to a signal transmitted from the secondary counting module that finishes counting.

2. The semi-automatic toilet bowl system of claim 1, wherein the sensing unit includes:
a cover opening/closing sensing module sensing a closed or open state of the cover of the toilet;
a use sensing module sensing whether a user uses and leaves the toilet; and
a seat cover sensing module sensing whether a seat cover of the toilet is rotated,
wherein when the seat cover sensing module senses that the seat cover of the toilet is opened up, the use sensing module is driven and senses the user.

3. The semi-automatic toilet bowl system of claim 2, wherein when the seat cover sensing module senses that the seat cover is opened up, but the use sensing module senses that there is no user, the controller controls the seat cover to automatically rotate over a bowl of the toilet.

4. The semi-automatic toilet bowl system of claim 1, wherein the controller includes:
a toilet control module controlling operation of the toilet;
a sensing unit control module receiving a signal from the sensing unit and controlling driving of the sensing unit;
a counting unit control module receiving a signal from the counting unit and controlling driving of the counting unit; and
a memory storing time input in advance in the counting unit.

5. The semi-automatic toilet bowl system of claim 1, wherein the toilet includes a speaker outputting an information voice informing a user that the toilet is available,
the sensing unit includes an entry sensing module sensing that a user enters a toilet stall equipped with the toilet, and
when the entry sensing module senses that a user enters the toilet stall, the controller outputs an information voice saying that the toile is available to the user by driving the speaker.
